(19) United States
(12) Patent Application Publication
(10) Pub. No.: US 2019/0234121 A1
(43) Pub. Date: Aug. 1, 2019

(54) FLUSH DOOR HANDLE ASSEMBLY

(71) Applicant: NOVARES US LLC, Livonia, MI (US)

(72) Inventors: RICHARD IRVING PUDNEY, PLYMOUTH, MI (US); ANTHONY REVEL, VILLIEU LOYES MOLLON (FR)

(73) Assignee: NOVARES US LLC, Livonia, MI (US)

(21) Appl. No.: 15/881,167

(22) Filed: Jan. 26, 2018

(51) Int. Cl. E05B 85/10; E05B 81/78; E05B 1/04; E05B 17/10

(52) U.S. Cl. CPC E05B 85/103; E05B 81/78; E05B 81/77; E05B 17/10; E05B 1/04

(57) ABSTRACT

A door handle assembly is provided that includes a cover element and a grip element. The cover element is movable between a flush position where the cover element fills an opening and is flush with a visible face of an outer door panel, and a retracted position where the cover element is displaced inwardly from the opening and the grip element and outer door panel defines a finger access space to receive fingers of a user. The assembly further includes an actuator to move the cover between the flush and retracted position, a hand sensor attached to the grip element to detect the user's fingers, a detection device to cooperate with a complementary transmitting device to identify the user, a latching mechanism unlatch the vehicle door when fingers are detected by the hand sensor, and a control unit to control the hand sensor, detection device, latching mechanism, and actuator.

### FIELD

The present disclosure relates to the field of automobile door handles.

### BACKGROUND

The statements in this section merely provide background information related to the present disclosure and may not constitute prior art.

The trend in automobile design is toward door handles that are flush with the sheet metal body of the vehicle door so that the vehicle has clean, unobstructed body surfaces. Conventional flush door handles are mounted in the vehicle door so that they can pivot between a flush position, in which they substantially fill an opening in the door, and an extended outboard position, in which they are outwardly positioned from the opening, thereby leaving an access for the fingers of the user.

### SUMMARY

The present disclosure provides fully automated flush door handles.

The present disclosure provides a door handle assembly and a method of operating such a door handle assembly.

The present disclosure provides a door handle assembly for a vehicle door, said door handle assembly having an outer door panel and comprising:

a cover element and a grip element, the cover element being movable between a flush position, in which the cover element substantially fills the opening and is substantially flush with a visible face of the outer door panel, and a retracted position, in which the cover element is displaced inwardly from the opening and in which the grip element defines in combination with the outer door panel a finger access space adapted to receive the fingers of a user;

an actuator of the cover element, configured to displace the cover element from the flush position to the retracted position and back from the retracted position to the flush position;

a hand sensor attached to the grip element, the hand sensor being configured to detect the fingers of the user within the finger access space;

a detection device configured to remotely cooperate with a complementary transmitting device carried by the user to identify the user;

a latching mechanism configured to unlatch the vehicle door when fingers are detected by the hand sensor; and

a control unit configured to control and command the hand sensor, the detection device, the latching mechanism, and the actuator of the cover element,

wherein the control unit being configured to command the actuator to displace the cover element from the flush position to the retracted position when the user is identified by the detection device, to give access, through the opening, to the finger access space, for the user's fingers.

According to an aspect, the door handle assembly further comprises a lighting device attached to the grip element, the lighting device being under control of the control unit, the control unit being configured to command the lighting device to light up when the detection device identifies the user.

According to an aspect, the grip element further comprises a backup latching mechanism, the backup latching mechanism being configured to be reachable through the opening when the cover element is in the retracted position.

The present disclosure also provides a method for operating the door handle assembly, the method comprising the following steps executed by the control unit:

identifying the user with the detection device;

commanding the actuator to displace the cover element from the flush position to the retracted position;

detecting with the hand sensor the fingers in the finger access space; and

commanding the latching mechanism to unlatch the vehicle door.

According to an aspect, the method for operating the door handle assembly further comprises the following steps executed by the control unit:

if the vehicle engine is started, command the actuator to displace back the cover element from the retracted position to the flush position;

if the vehicle engine is stopped, and the user still identified by the detection device, command the actuator to displace the cover element from the flush position to the retracted position and command the latching mechanism to unlatch the vehicle door; and

if the vehicle engine is stopped and if the vehicle door is closed, and if the user is not identified by the detection device, command the actuator to displace back the cover element from the retracted position to the flush position;

According to an aspect, the control unit commands the lighting device to light up each time said control unit commands the actuator to displace the cover element from the flush position to the retracted position, and wherein the control unit commands the lighting device to light off each time said control unit commands the actuator to displace back the cover element from the retracted position to the flush position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an external perspective view of a visible part of a vehicle door, as seen from outside of the vehicle, with a door handle assembly cover element in a flush position in accordance with the teaching of the present disclosure;

FIG. 2 is a perspective view of a grip element and a cover element in a flush position filling an opening according to the present disclosure;

FIG. 3 is a perspective view of a grip element and a cover element in a retracted position according to the present disclosure;

FIG. 4a is a cross-section representation of a door handle assembly with a cover element in a flush position according to the present disclosure;

FIG. 4b is a cross-section representation of a door handle assembly with a cover element in a retracted position according to the present disclosure;

FIG. 4c is a cross-section of a door handle assembly with a cover element in a retracted position and fingers inside a finger access space according to the present disclosure; and

FIG. 4d is a cross-section of a door handle assembly with a cover element in a retracted position and a backup opening mechanism according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a door handle assembly for a vehicle door.

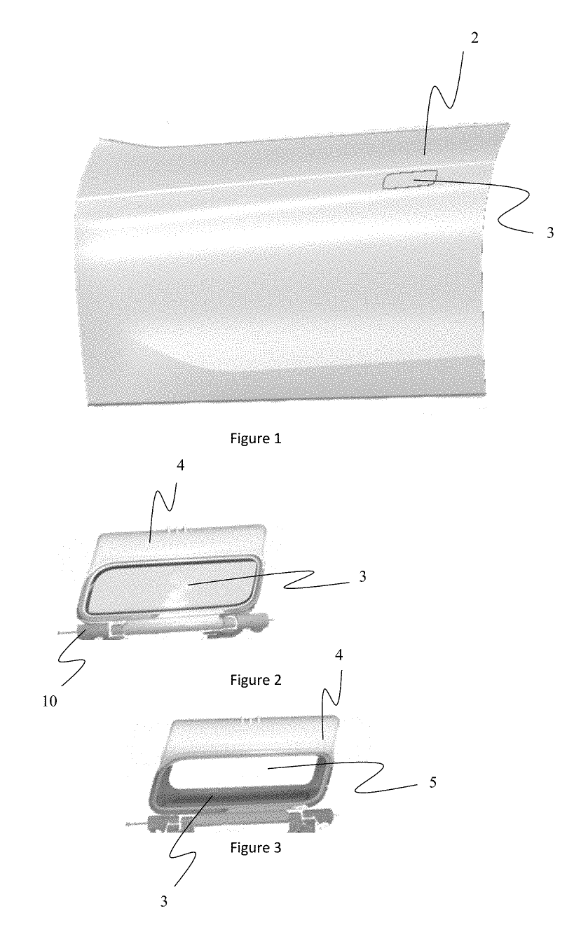

Referring to FIGS. 1 to 5, 6a-6d, the present disclosure is described in relation to an embodiment thereof.

FIG. 1 illustrates a visible part of the door handle assembly 1 when it is flush with an adjacent outboard surface of an outer vehicle door panel 2. In FIG. 1, the only visible part of the door handle assembly 1 is the cover element 3 in flush position, so that the aesthetic aspect of the outdoor panel is not affected.

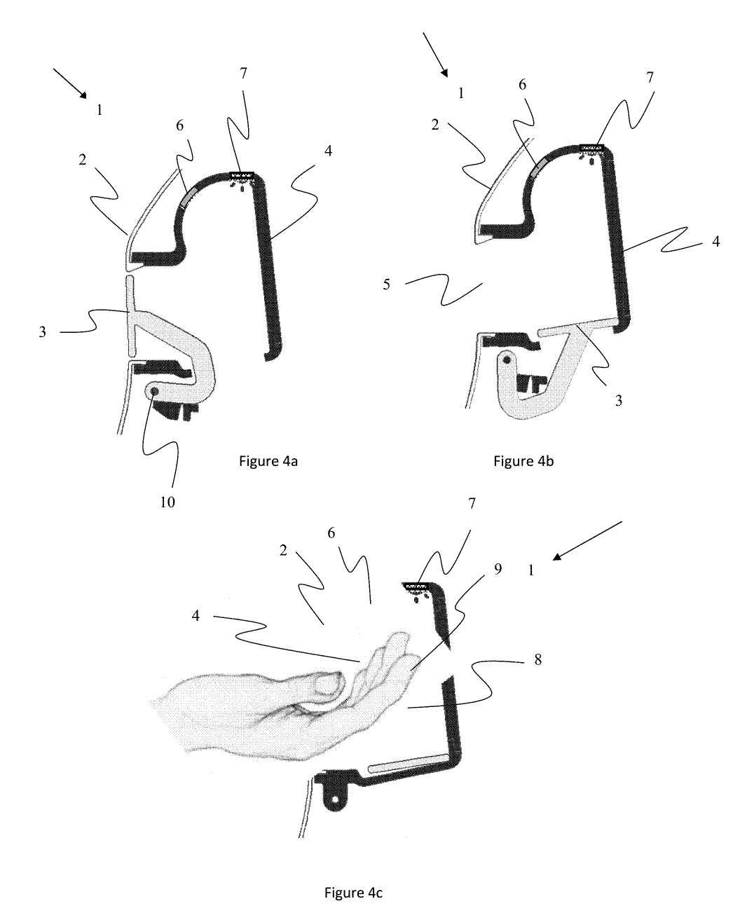

FIGS. 2 and 3 illustrate the cover element 3 and the grip element 4, the cover element 3 being movable between a flush position as in FIG. 2 and a retracted position as in FIG. 3. In its flush position, the cover element 3 substantially fills the opening 5 and is substantially flush with the visible face of the outer door panel 2, which is not represented in FIGS. 2 and 3.

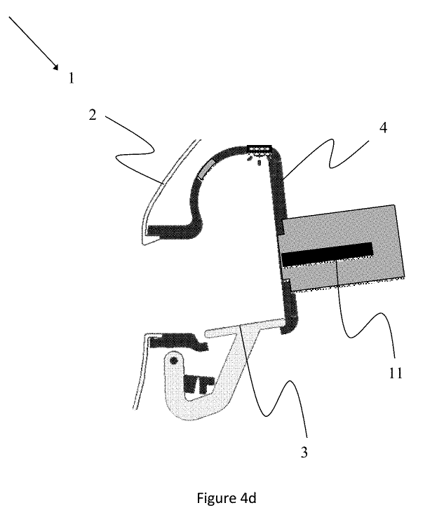

FIG. 4a-4c are cross-sectional representations of the door handle assembly 1, comprising the cover element 3 in flush position, as in FIG. 4a, and in retracted position as in FIGS. 4b and 4c. In a retracted position, the cover element 3 is displaced inwardly from the opening 5 and a grip element 4 defines in combination with the outer door panel 2 a finger access space 8 adapted to receive the fingers 9 of a user, as it is represented in FIG. 4c.

The door handle assembly 1 further comprises an actuator 10, such as an electrical motor for example, to displace the cover element 3 from the flush position and the retracted position. In the form described here, the displacement of the cover element 3 is a rotation around a longitudinal axis substantially parallel to the outer door panel 2.

The door handle assembly 1 further comprises a command and control unit, not represented on the figures. Said command and control unit is configured to command and control the actuator 10 of the cover element 3.

The door handle assembly 1 further comprises a hand sensor 6. The hand sensor 6 is fixed to the grip element 4, on the wall of the finger access space 8 defined by the grip element in combination with the outer door panel 2. The hand sensor 6 is configured to detect the presence of fingers 9 of a user, who has slipped his hand through the opening 5 when the cover element 3 is in retracted position.

The detection device is under control of the command and control unit, which is further configured to receive and process appropriate information from the hand sensor.

The door handle assembly 1 further comprises a detection system, comprising a detection device, not represented on the figures, which in one form is a radio detection device with an antenna and a radio receptor integrated on the vehicle. The detection device is configured to remotely cooperate with a complementary transmitting device, for example a transmitting key fob held by a user, to identify the user authorized to use the vehicle.

The detection device is under control of the command and control unit, which is further configured to receive and process identification information from the detection device.

The door handle assembly 1 further comprises a latching mechanism, not represented on the figures. The latching mechanism is configured to latch or unlatch the vehicle door. When the door in unlatched, it can be opened by just pulling the door. The latching mechanism is under control of the command and control unit, which is further configured to automatically actuate the latching mechanism to unlatch the door when the hand sensor 6 detects the fingers 9 of a user, who therefore only needs to grip the grip element 4 to pull the door open. When the door is pulled closed, the latching mechanism will mechanically latch.

Advantageously, the door handle assembly 1 further comprises a lighting device 7, attached to the grip element 4 and under control of the command and control unit, the lighting device 7 being configured to light up when the detection device identifies the user, in order to illuminate the opening 5 and help the user to find the opening 5, especially by night.

Advantageously, the command and control unit is configured to receive information on whether the vehicle engine is being started by the user. When the command and control unit receives information on the vehicle engine being started, the command and control unit will actuate the displacement of the cover element 3 from the retracted position to the flush position and command the lighting device to shut off the light.

Advantageously, the grip element 4 comprises a backup latching mechanism 11 configured to unlatch the door by using a mechanical key. As represented on FIG. 4d, the backup latching mechanism 11 is arranged to be reachable by the user when the cover element 3 is in retracted position, to actuate mechanically the latching mechanism of the door when the command and control unit fails to actuate the latching mechanism.

The operation of the door handle assembly 1 will now be described. Initially, the door handle assembly is in the position illustrated in FIG. 1, the cover element 3 being flush with the outer door panel 2. The locking mechanism is in the locking position, and the latching mechanism is in the latched position. The command and control unit determines if the detection device receives a signal from a complementary transmitting device, such as a key fob, indicating that an authorized user is approaching. If yes, the command and control unit actuates the lighting up of the lighting device 7, and actuates the displacement of the cover element 3 from the flush position to the retracted position, so that the user is guided towards the opening 5 and the finger access space 8, into which he just has to slip his fingers, to grip the grip element 4. Thus, the hand sensor 6 detects the fingers of the user and the command and control unit actuates the unlatching of the door, so that the user just has to pull the door open. Thereafter, the command and control unit determines if the door is closed, the user is still identified, and the engine started: if these conditions are satisfied, the command and control unit actuates the displacement of the cover element 3 back to the flush position, and actuates the lighting device 7 to shut off the light.

When the engine is stopped, and the command and control unit determines that the user is actuating the latching mechanism to unlatch the door, the command and control unit actuates the lighting device 7 to light on again and the cover element 3 to displace from the flush position to the retracted position. Once the command and control unit determines that the door is closed and the user is far enough, the command and control unit actuates the displacement of the cover element 3 back to the flush position, and actuates the lighting device 7 to shut off the light.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A door handle assembly for a vehicle door having an outer door panel, said door handle assembly comprising:
a cover element movable between a flush position where the cover element fills an opening defined by the outer door panel and is substantially flush with a visible face of the outer door panel, and a retracted position where the cover element is displaced inwardly from the opening, wherein a grip element and the outer door panel define a finger access space adapted to receive fingers of a user;
an actuator configured to move the cover element between the flush position and the retracted position;
a hand sensor attached to the grip element, the hand sensor configured to detect fingers of the user within the finger access space;
a detection device configured to remotely cooperate with a complementary transmitting device carried by the user to identify the user;
a latching mechanism configured to unlatch the vehicle door when fingers are detected by the hand sensor; and
a control unit configured to control the hand sensor, the detection device, the latching mechanism, and the actuator,
wherein the control unit commands the actuator to displace the cover element from the flush position to the retracted position when the user is identified by the detection device.

2. The door handle assembly of claim 1 further comprising a lighting device attached to the grip element and controlled by the control unit, wherein the control unit commands the lighting device to light up when the detection device identifies the user.

3. Door handle assembly according to claim 2, wherein the grip element further comprises a backup latching mechanism that is reachable through the opening when the cover element is in the retracted position.

4. A method for operating the door handle assembly of claim 1 with a control unit, the method comprising:
identifying the user with the detection device;
commanding the actuator to displace the cover element from the flush position to the retracted position;
detecting fingers of the user in the finger access space with the hand sensor; and
commanding the latching mechanism to unlatch the vehicle door.

5. The method of claim 4 further comprising at least one of:
commanding the actuator to displace the cover element from the retracted position to the flush position when the vehicle engine is operating;
commanding the actuator to displace the cover element from the flush position to the retracted position and the latching mechanism to unlatch the vehicle door when the vehicle engine is stopped and the user is identified by the detection device; and
commanding the actuator to displace the cover element from the retracted position to the flush position when the vehicle engine is stopped, the vehicle door is closed, and the user is not identified by the detection device.

6. The method of claim 5, wherein the control unit commands a lighting device to light up each time said control unit commands the actuator to displace the cover element from the flush position to the retracted position.

7. The method of claim 5, wherein the control unit commands a lighting device to light off each time said control unit commands the actuator to displace the cover element from the retracted position to the flush position.
